(19) United States
(12) Patent Application Publication
(10) Pub. No.: US 2014/0322431 A1
(43) Pub. Date: Oct. 30, 2014

(54) PREDICTING A CHARACTERISTIC OF AN OVERCOAT

(71) Applicant: HGST NETHERLANDS B.V., Amsterdam (NL)

(72) Inventors: Simone Pisana, San Jose, CA (US); Franck Rose, San Jose, CA (US)

(73) Assignee: HGST Netherlands B.V., Amsterdam (NL)

(21) Appl. No.: 13/869,431

(22) Filed: Apr. 24, 2013

(51) Int. Cl. G06F 17/18; G11B 5/84

(52) U.S. Cl. CPC G06F 17/18; G11B 5/84
USPC 427/8; 702/181

(57) ABSTRACT

A method for predicting a characteristic of an overcoat for a media for a hard disc drive is disclosed. An overcoat is probed via a microscope using inelastic scattering of a photon by optical phonons from the overcoat to generate data related to in-plane bond-stretching motion of pairs of atoms of the overcoat. The data is fit to a curve at a computer system. A characteristic of the overcoat is predicted based on the curve at the computer system.

### BACKGROUND ART

A hard disc drive (HDD) may be used by a computer system for operations. In fact, most computing systems are not operational without some type of data storage such as a HDD to store the most basic computing information such as the boot operation, the operating system, the applications, and the like. In general, the HDD is a component for use in a computer system or may be used as a component of dedicated remote data storage systems for use in cloud computing. A HDD often uses a media or substrate such as a hard disc. The hard disc may be composed of a material that has varying characteristics.

### BRIEF DESCRIPTION OF THE DRAWINGS

FIG. 1 is a schematic diagram of an HDD in accordance with embodiments of the present invention.

FIG. 2 is a schematic diagram of a disc in accordance with embodiments of the present invention.

FIG. 3 is a schematic diagram of a disc with predicting equipment in accordance with embodiments of the present invention.

FIG. 4 is a schematic diagram of structures of atoms in accordance with embodiments of the present invention.

FIG. 5 is a plot of data and fitted curves in accordance with embodiments of the present invention.

FIG. 6 is a flow chart of a method for predicting a characteristic of an overcoat for a media for a hard disc drive in accordance with embodiments of the present invention.

FIG. 7 is a flow chart of a method for manufacturing a disc for a hard disc drive in accordance with embodiments of the present invention.

FIG. 8 is a flow chart of a method for predicting characteristics of a film in accordance with embodiments of the present invention.

### DESCRIPTION OF EMBODIMENTS

Reference will now be made in detail to various embodiments of the present invention. While the invention will be described in conjunction with these embodiments, it should be understood that the described embodiments are not intended to limit the invention to these embodiments. On the contrary, the invention is intended to cover alternatives, modifications and equivalents, which may be included within the spirit and scope of the invention as described in the various embodiments and as defined by the appended claims.

Furthermore, in the following description of embodiments, numerous specific details are set forth in order to provide a thorough understanding of various embodiments of the present invention. However, it will be recognized by one of ordinary skill in the art that embodiments of the present invention may be practiced without these specific details. In other instances, well known methods, procedures, components, and circuits have not been described in detail as not to unnecessarily obscure aspects of embodiments of the present invention.

### Overview of Discussion

The discussion will begin with a brief overview of the present invention. The discussion will then focus on a hard disc drive (HDD) and components connected therewith. The discussion will then focus on embodiments of predicting a characteristic of an overcoat or film. In particular, the present technology is for predicting one or more characteristics of an overcoat or film where the characteristics include mass density, sp3/sp2 bonding ratio, and graphitization. In one embodiment, the overcoat or film is diamond like carbon (DLC) that is a layer in a disc employed in a HDD.

A HDD may include one or several discs where the discs are each composed of a plurality of layers. One such layer may be a media suitable for recording data to and subsequently reading the data from the media. The disc may have many other layers such as substrates or an overcoat. The overcoat may be a layer over the media such that the overcoat offers a measure of protection to the media. In practice, the overcoat may be a film comprised of a variety of different materials including carbon. During the manufacturing process, different layers of the disc may be tested or probed to determine characteristics of the disc and its layers. For example, the overcoat layer may be tested or probed to determine its mass density or sp3/sp2 content ratio.

Different technique used to determine the mass density of a carbon overcoat layer includes x-rays and refraction. For example, mass density may be measured on thicker carbon overcoat (COC) films by X-Ray Reflectivity (XRR) and the sp3/sp2 content ratio by X-ray Photoelectron Spectroscopy (XPS). These two methods require several hours of measurements and of modeling and fitting. For example, XRR and XPS usually requires several hours to complete. This time period makes it prohibitive to test every disc or even a substantial portion of every disc being manufactured. These techniques may also be difficult to automate. Moreover, the x-rays in these techniques may also damage the disc itself.

In one embodiment, the present technology tests or probes an overcoat of a disc during a manufacturing process of the disc. The overcoat or film may first be deposited over a recording media of the disc. A microscope is used to probe the overcoat. For example, the microscope may employ Raman spectroscopy to probe the atomic structure of the overcoat. The probing results in data that is generated. In one embodiment, the probing includes data related to the in-plane bond-stretching motion of pairs of carbon sp2 atoms. The data may be analyzed by a computer system. The computer system may fit the data to a line or curve. For example, the data may be fit to a Gaussian curve with a G band. The G band may have an associated G position and G width. In one embodiment, the position (Gpos) is mapped in function of the full width at half maximum (Gwidth) of the G Gaussian band. The calculated or fitted data curve may then be used to predict mass density, sp3/sp2 bonding ratio, and graphitization of the overcoat layer.

The present technology offers nondestructive and fast predictions of the mass density, sp3/sp2 bonding ratio, and graphitization of the overcoat layer. The present technology is compatible with disc manufacturing techniques and high throughput, to make the predictions. In one embodiment, the present technology employs Raman spectroscopy to gather data and make the predictions. In one embodiment, a method relies on plotting the variation of the Raman G band position in function of its width at half maximum. This method can be used to characterize COO films and used as a quick process monitoring and failure analysis method. The present technology is capable of automation and may test every disc manufactured or a pre-determined portion. The fast throughput of the present technology allows it to be implemented on a manufacturing line for quick process monitoring and as a failure analysis method.

### Operation

The basic HDD model includes a magnetic storage disc, hard disc, or media that spins at a designed rotational speed. Layers of the media may comprise a segregant and may be etched using the present technology. An actuator arm with a suspended slider is utilized to reach out over the disc. The slider may comprise one or more magnetic read and write transducers or heads for reading and writing information to or from a location on the disc. The slider may also comprise a heater coil designed to change shape when heat is transferred to the heater coil by means of electric current. The slider is mounted on a suspension which connects to the actuator arm. In the case of multiple platter drives, there can be multiple suspensions attaching to multiple actuator arms as components of a head stack assembly. The head stack assembly also includes a voice coil which is part of a motor used for moving the arms to a desired location on the disc(s).

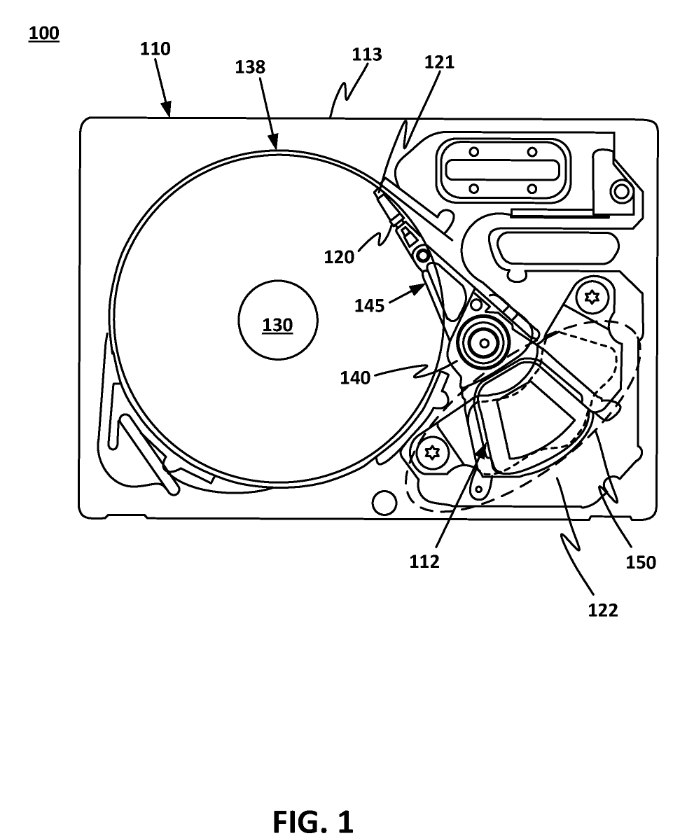

With reference now to FIG. 1, a schematic drawing of one embodiment of an information storage system including a magnetic hard disc file or HDD 110 for a computer system is shown, although only one head and one disc surface combination are shown. What is described herein for one head-disc combination is also applicable to multiple head-disc combinations. In other words, embodiments of the present technology are independent of the number of head-disc combinations. FIG. 1 represents an information storage device that is in accordance with embodiments of the present technology for predicting a characteristic of an overcoat or film for a media for a hard disc drive.

In general, HDD 110 has an outer housing 113 usually including a base portion (shown) and a top or cover (not shown). In one embodiment, housing 113 contains a disc pack having at least one media or magnetic disc 138. The disc pack (as represented by disc 138) defines an axis of rotation and a radial direction relative to the axis in which the disc pack is rotatable.

A spindle motor assembly having a central drive hub 130 operates as the axis and rotates the disc 138 or discs of the disc pack in the radial direction relative to housing 113. An actuator assembly 140 includes one or more actuator arms 145. When a number of actuator arms 145 are present, they are usually represented in the form of a comb that is movably or pivotally mounted to base/housing 113. An actuator arm controller 150 is also mounted to base 113 for selectively moving the actuator arms 145 relative to the disc 138. Actuator assembly 140 may be coupled with a connector assembly, such as a flex cable to convey data between arm electronics and a host system, such as a computer, wherein HDD 110 resides.

In one embodiment, each actuator arm 145 has extending from it at least one cantilevered integrated lead suspension (ILS) 120. The ILS 120 may be any form of lead suspension that can be used in a data access storage device. The level of integration containing the slider 121, ILS 120, and read and write head is called the head stack assembly.

The ILS 120 has a spring-like quality, which biases or presses the air-bearing surface of slider 121 against disc 138 to cause slider 121 to fly at a precise distance from disc 138. Slider 121 may have a pole tip which protrudes at various lengths from slider 121. Slider 121 may also contain a read head, a write head and a heater coil. ILS 120 has a hinge area that provides for the spring-like quality, and a flexing cable-type interconnect that supports read and write traces and electrical connections through the hinge area. A voice coil 112, free to move within a conventional voice coil motor magnet assembly is also mounted to actuator arms 145 opposite the head stack assemblies. Movement of the actuator assembly 140 causes the head stack assembly to move along radial arcs across tracks on the surface of disc 138. In one embodiment, actuator arm controller 150 controls a plurality of actuator arms associated with a plurality of discs.

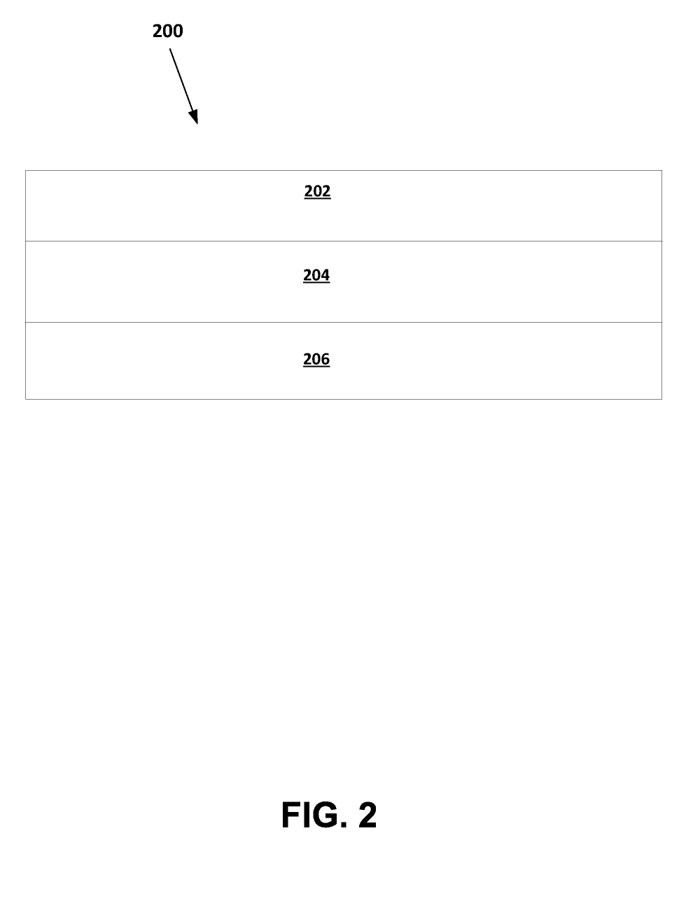

Reference will now be made to FIG. 2, a schematic diagram of a cross section of disc 200 in accordance with embodiments of the present invention. FIG. 2 depicts overcoat 202 over media 204 over substrate 206 which comprise disc 200. Disc 200 may be a disc that is employed in a HDD for reading and writing data. A HDD may comprise a plurality of disc. A disc may also be double sided meaning that there may be a second layer media layer on the opposite side of substrate 206 as well as a second overcoat. It should be appreciated that each of overcoat 202, media 204, and substrate 206 may be comprised of a plurality of individual layers or may each be a single layer. Moreover, disc 200 may comprise layers not depicted such as glass layers, under layers, etc. In a manufacturing process overcoat 202 may be deposited over media 204.

In one embodiment, overcoat 202 is designed to be over media 204 such that it covers a surface of media 204 and may or may not be in physical contact with media 204. In one embodiment, overcoat 202 protects media 204 from corrosion while allowing data to be written to and read from media 204. Overcoat 202 may be a film or thin film. Overcoat 202 may be comprises of a variety of different materials and may be a carbon overcoat (COC). In one embodiment, overcoat 202 is comprised of diamond like carbon (DLC) which includes atoms bonded to one another at various hybrid orbitals including sp2 and sp3 orbitals. Overcoat 202 may comprise other characteristics such as mass density and graphitization. Different qualities of materials and different manufacturing environment variables may cause the characteristics of overcoat 202 to fluctuate or vary. This may be true between a first overcoat over a first disc and second overcoat over a second disc even if the first and second overcoats are produced using the same manufacturing equipment and processes. Therefore, probing or other testing techniques are employed to determine the characteristics of an overcoat. Parameters may be established for the characteristics of the overcoat and a determination may be made as to whether the characteristics of overcoat 202 fall within the parameters. The parameters may set limits as to what levels are acceptable for a disc to be used for a HDD.

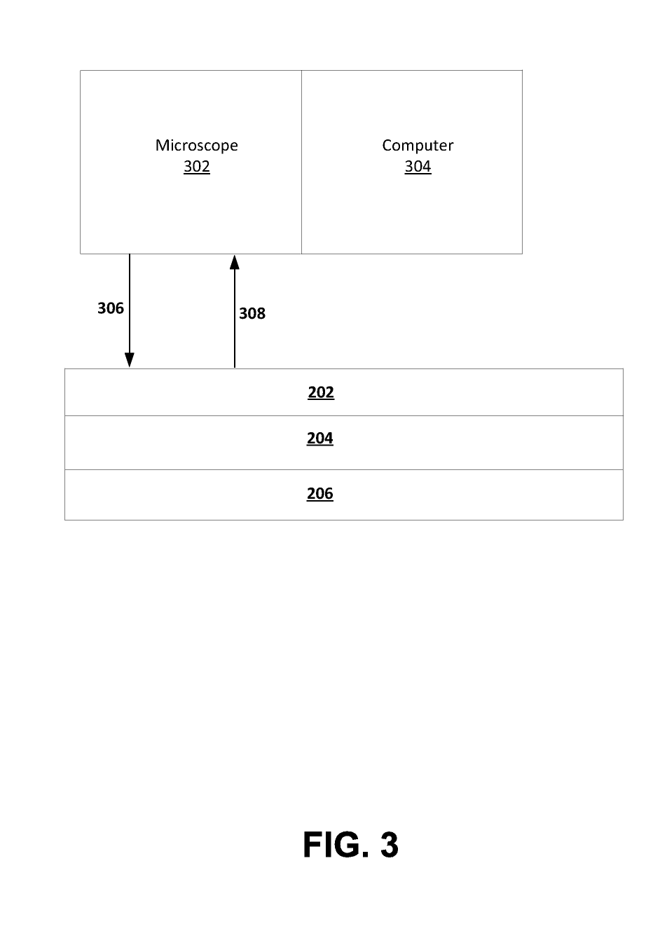

Reference will now be made to FIG. 3, a schematic diagram of a disc with predicting equipment in accordance with embodiments of the present invention. FIG. 3 depicts an environment of where testing equipment is used to probe the characteristics of overcoat 202. In one embodiment, overcoat 202 is deposited over media 204 before such probing occurs. However, it is possible to use techniques of the present technology to probe materials for overcoat 202 that are not deposited over layers of a disc. Microscope 302 may comprise standard microscope components as well other components that are capable of projecting light and measuring light. For example, microscope 302 may be a confocal Raman microscope that employs Raman spectroscopy to probe overcoat 202 and gather data regarding overcoat 202. Microscope 302 is able to employ techniques that use the inelastic scattering of a photon by optical phonons in overcoat 202. This allows for the probing of the in-plane bond-stretching motion of pairs of carbon sp2 atoms in DLC overcoats.

In one embodiment, microscope 302 is used to project light 306 onto a surface of overcoat 202. Light 306 may be generated by a laser associated with microscope 302. Light 306 has characteristics such as wavelength and frequency that are known to microscope 302 and/or computer 304. In one embodiment, light 306 is reflected and scattered by the surface of overcoat 202 and becomes scattered light 308. At least a portion of scattered light 308 may be intercepted by sensor associated with microscope 302. The sensor is able to determine characteristics of scattered light 308 such as it wavelength and frequency. The characteristics of scattered light 308 may be referred to as data. The data generated or gathered by microscope 302 and its components may be sent to computer 304.

Computer 304 is a computer system capable of manipulating data via a processor and memory. Computer 304 may be a standard computer system such as a general purpose computer system, a person computer, a server computer, or may be built as a specific use computer system designed for the present technology and for the manufacturing of discs for HDDs. Computer 304 may be attached or coupled to microscope 302 or may be connected to microscope 302 via cables or wireless communication channels. Computer 304 may be physically proximate to microscope 302 or may be physically remote and connected via a network. Other components may be in place to send data from microscope 302 to computer 304 such as a router. In one embodiment, computer 304 controls the components and processes of microscope 302. In one embodiment, computer 304 is a component of microscope 302. The present technology may require various computations to take place, such computations may take place at computer 304 or a portion of the computation may occur at microscope 302 and a portion at computer 304.

In one embodiment, computer 304 knows the characteristics of light 306 projected by microscope 302 and knows the characteristics of scattered light 308 received by microscope 302. By analyzing the differences between light 306 and scattered light 308, computer 304 may make determinations or predictions about the characteristic of overcoat 202 or other material. In one embodiment, microscope 302 and computer 304 are used to measure the in-plane bond stretching motion of pairs of carbon (C) sp2 atoms in overcoat 202. Computer 304 is capable of plotting data and fitting lines or curves with their associated equations to the plotted data. In one embodiment, data acquisition and analysis by microscope 302 and computer 304 are automated. In one embodiment, the processes used to probe and make predication about overcoat 202 via microscope 302 and computer 304 takes approximately two minutes.

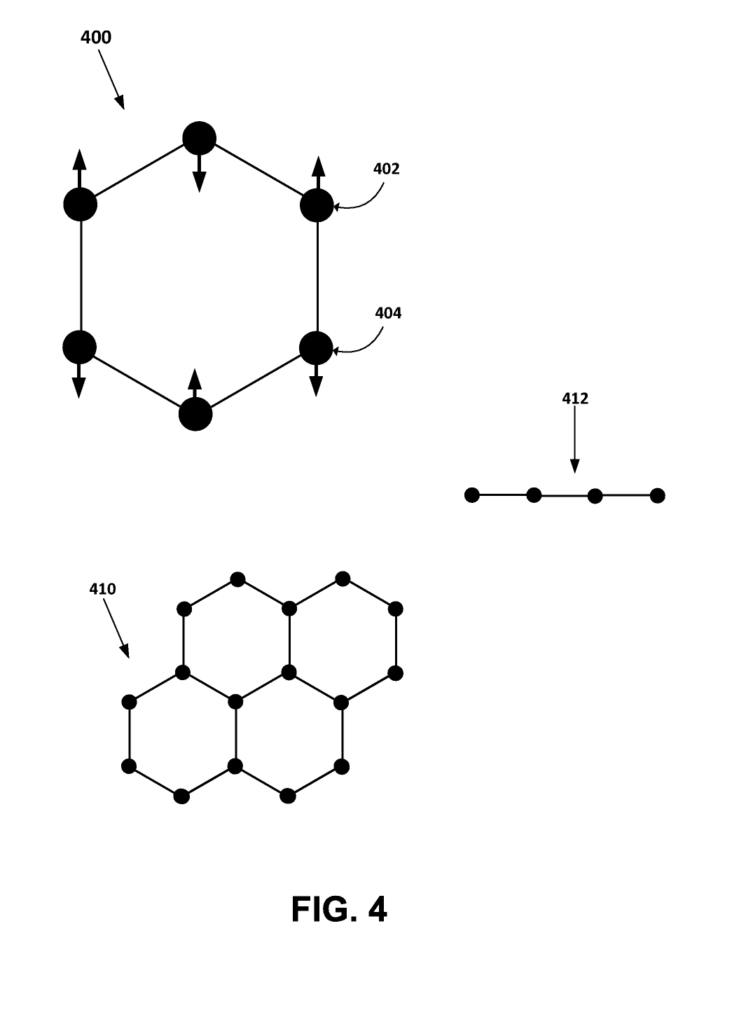

Reference will now be made to FIG. 4, a schematic diagram of structures of atoms in accordance with embodiments of the present invention. Structures 400 and 410 of FIG. 4 depict atomic structures of materials used for overcoat 202 of FIG. 2. For example, atom 402 may be a carbon atom bonded with two other carbon atoms to ultimately form structure 400. Structure 400 is depicted as comprising 6 atoms forming a ring or hexagonal structure. The atoms may have different hybrid orbitals such as sp2 or sp3. In one embodiment, atoms 402 and 404 are a pair of carbon sp2 atoms in an overcoat. The arrows associated with atoms 402 and 404 and the other atoms of structure 400 depict the forces at play between the pairs of atoms and relate to the in-plane bond stretching motion of pairs of carbon sp2 atoms. Structure 410 depicts a plurality of atoms, which may be carbon atoms in a ring type bonding structure. Structure 412 depicts a plurality of atoms in a chain.

In one embodiment, overcoat 202 also contains open chains of carbon such as structure 412. Chains and rings form small clusters of sp2 bonded atoms. These sp2 clusters are linked together by sp3 bonding to form the continuous diamond like carbon overcoat (DL-COC) film. Moreover, the microstructure of a DL-COC film is amorphous, meaning no long range order, which means that the size of the sp2 clusters is very small, about 1 nanometer in diameter. Overcoat 202 may be comprised of a plurality of atoms bonded into either structure 400, 410, or 412 patterns, or a combination thereof.

Raman spectroscopy is sensitive to the in-plane bond stretching motion of any pair of sp2 carbon atoms. This means that the Raman spectroscopy can detect any pair of atoms arranged in rings or in chains. The G band of the Raman spectrum is the measurement of the in-plane bond stretching motion of all pairs of sp2 carbon atoms. Thus the G band comes from C-C pairs inside rings and chains.

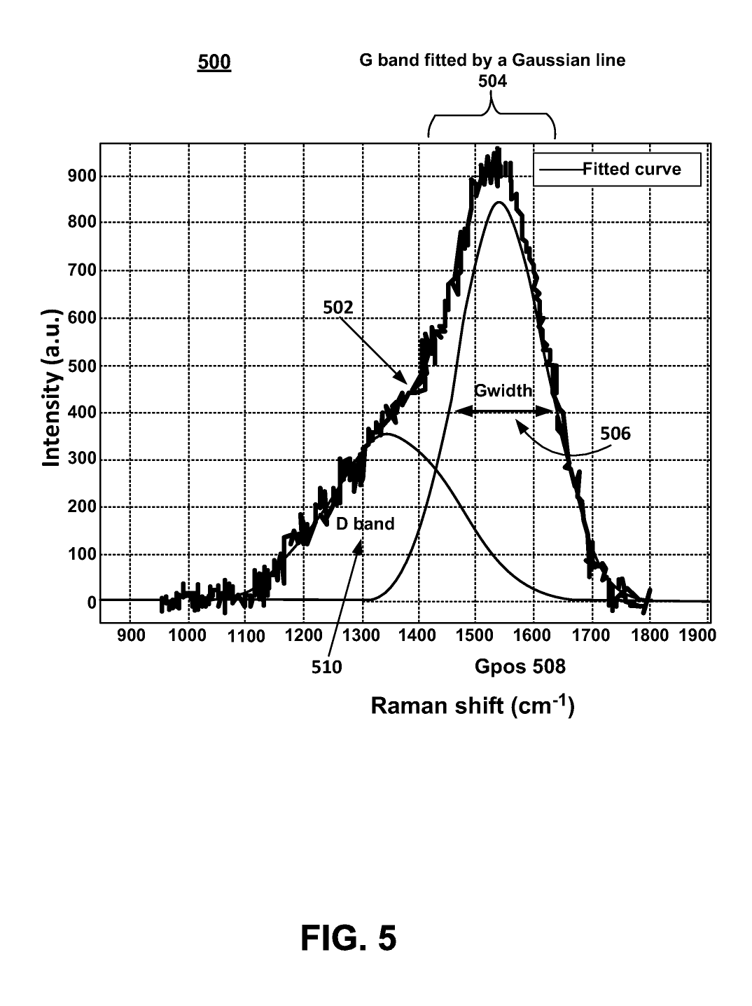

Reference will now be made to FIG. 5, is a plot of data and fitted curves in accordance with embodiments of the present invention. In one embodiment, plot 500 of FIG. 5 is generated by computer 304 of FIG. 3. Data 502 may be data related to scattered light 308 and gathered by microscope 302 and computer 304 of FIG. 3. Data 502 is depicted as plotted on a graph or chart of a Raman shift versus an intensity where the Raman shift is measured in centimeters⁻¹ and the intensity is measured in arbitrary units (a.u.). In one embodiment, computer 304 of FIG. 3 fits a line or curve to data 502. The fitted curve and its corresponding equation may be referred to as a Gaussian curve or line. In one embodiment, data may have two bands or peaks referred to as a D band or peak and a G band or peak. FIG. 5 depicts both G band 504 and D band 510 where G band 504 is fitted by a Gaussian line. FIG. 5 also depicts the G position of G band 504 as Gpos 508 as well as the G width of G band 504 as Gwidth 506. In one embodiment, computer 304 may map Gpos 508 in function of the full width at half maximum of Gwidth 506. Such mapping may then be employed to make predictions regarding characteristics of overcoat 202 of FIG. 2. Such predictions include predicting the characteristics of the mass density, sp3/sp2 bonding ratio, and graphitization of overcoat 202. In one embodiment, the present technology only uses the G band to make predications for the characteristics of the overcoat and does not employ data from the D band.

G band 504 may be described as a Raman G band. G band 504 may be fitted by a Gaussian line using the following equation: Gband=Intensity*exp{−[(x−Gpos)/(√2*Gwidth/2)]̂2}, where x is the Raman shift. Plot 500 demonstrates that the higher the values of Gpos 508 and Gwidth 506 are, the denser and higher the sp3 content is in the overcoat. Additionally, if Gpos 508 and Gwidth 506 are low then the film is graphitized, meaning that it has a lower sp3 content and a high sp2 content.

Gpos 508 and Gwidth 506 may be employed to make other plots used to make predictions regarding characteristics of the overcoat. For example, a second plot, not depicted, may be made by computer 304 of FIG. 3 where the x-axis is Gwidth 506 and the y-axis is Gpos 508. This plot may be employed to make predictions regarding the density and graphitization of an overcoat such as a CHx overcoat, deposited via chemical vapor deposition (CVD). Such a plot shows the higher the values of the Gpos 508 and Gwidth 506, the higher the mass density of the overcoat. Thus the present technology may replace techniques such as XRR previously used to make such measurements. Such as plot also demonstrates that after thermal annealing, the Gpos is getting higher and the Gwidth is getting lower, the overcoat has graphitized meaning that it has a lower sp3 content and a high sp2 content.

A third plot, not depicted, may also be generated to show a comparison between a “low sp3-low density” overcoat, such as a CHx deposited by CVD, and a “high sp3 content-high density” overcoat deposited by filtered cathodic arc (FCAC). The third plot would show that at room temperature (21 C) it is clear that the high sp3 content and high density of the FCAC is correlated with its higher Gpos and Gwidth than the CHX (CVD) overcoat. After thermal annealing, the third plot shows that FCAC is more thermally stable than CHx (CVD). Therefore the present technology may be used to create tables or charts that depict a comparison and ranking of different overcoats.

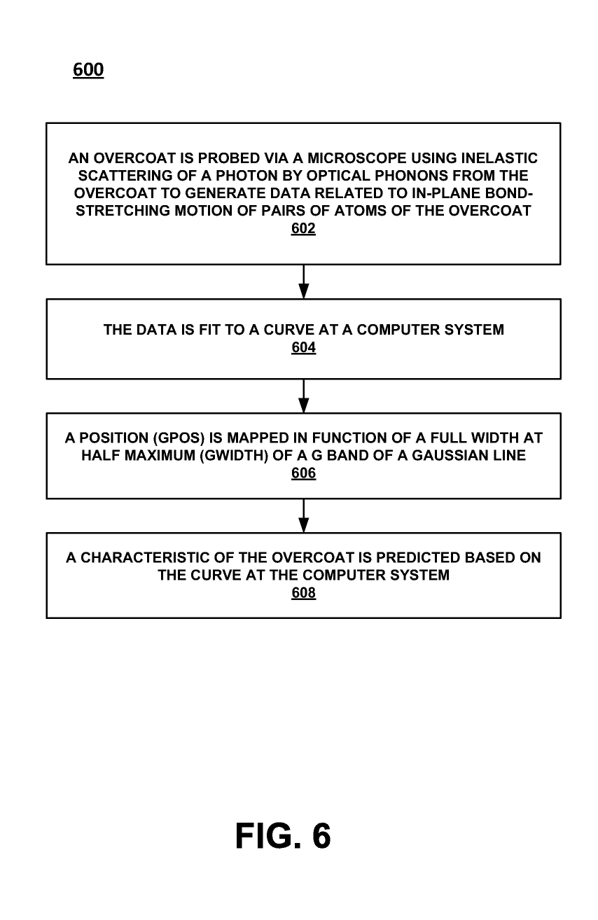

FIG. 6 is a flowchart illustrating process 600 for predicting a characteristic of an overcoat for a media for a hard disc drive, in accordance with embodiments of the present technology. Process 600 may be for a disc used in a HDD such as is depicted in FIGS. 1 and 2. The components used for process 600, as well as its steps and results are depicted in FIGS. 3, 4, and 5.

At 602, an overcoat is probed via a microscope using inelastic scattering of a photon by optical phonons from the overcoat to generate data related to in-plane bond-stretching motion of pairs of atoms of the overcoat. For example, the overcoat may be overcoat 202 of FIG. 2 and the microscope may be microscope 302 of FIG. 3. The probing may be accomplished by sending or shining light onto a surface of the overcoat such as light 306. The data may be the characteristics of the scattered light, such as scattered light 308, reflected from the surface of the overcoat and gathered by a sensor associated with the microscope. 602 may be referred to as probing, measuring, or generating.

The overcoat may be comprised of carbon or diamond like carbon and may be a thin film. A carbon overcoat may be comprised of sp2 and sp3 atoms in bonding pairs. The overcoat may be a layer in a disc to be used in a HDD such as disc 200 of FIG. 2. The microscope may be a confocal Raman microscope that uses Raman spectroscopy.

At 604, the data is fit to a curve at a computer system. The computer system may be computer 304 of FIG. 3. The curve may be a Gaussian curve and may be plotted as depicted by plot 500 of FIG. 5. The Gaussian curve may have a G band, a G position and a G width. Step 604 may be referred to as fitting, calculating, computing, or generating.

At 606, a position (Gpos) is mapped in function of a full width at half maximum (Gwidth) of a G band of a Gaussian line. The Gpos may be Gpos 508 and the Gwidth may be Gwidth 506 of FIG. 5. Such mapping allows the computer system to analyze the data to make predications. Step 606 may be referred to as mapping.

At 608, a characteristic of the overcoat is predicted based on the curve at the computer system. For example, the characteristics may be a mass density of the overcoat, an sp3/sp2 bonding ratio of the overcoat, and a graphitization of the overcoat. The characteristic may be based on the Gpos and the Gwidth mapping. Step 608 may be referred to as predicting, generating, determining, or characterizing.

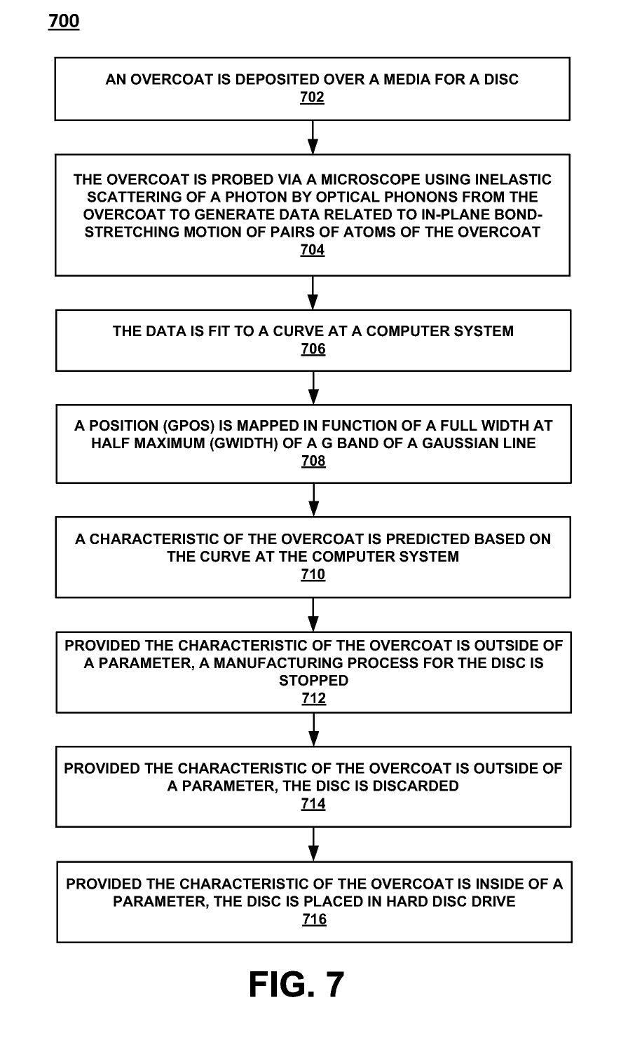

FIG. 7 is a flowchart illustrating process 700 for manufacturing a disc for a hard disc drive, in accordance with embodiments of the present technology. Process 700 may be for a disc used in a HDD such as is depicted in FIGS. 1 and 2. The components used for process 700, as well as its steps and results are depicted in FIGS. 3, 4, and 5.

At 702, an overcoat is deposited over a media for a disc. The overcoat may be comprised of carbon or diamond like carbon and may be a thin film. A carbon overcoat may be comprised of sp2 and sp3 atoms in bonding pairs. The overcoat may be a layer in a disc to be used in a HDD such as disc 200 of FIG. 2. The method for manufacturing the disc may be automated. For example, robotic arms may be employed to move the disc after the overcoat is deposited such that the disc is placed under a microscope for step 704.

At 704, the overcoat is probed via a microscope using inelastic scattering of a photon by optical phonons from the overcoat to generate data related to in-plane bond-stretching motion of pairs of atoms of the overcoat. For example, the overcoat may be overcoat 202 of FIG. 2 and the microscope may be microscope 302 of FIG. 3. The microscope may be a confocal Raman microscope that uses Raman spectroscopy. The probing may be accomplished by sending or shining light onto a surface of the overcoat such as light 306. The data may be the characteristics of the scattered light, such as scattered light 308, reflected from the surface of the overcoat and gathered by a sensor associated with the microscope.

It should be appreciated that different steps of the manufacturing process may occur faster or slower than one another. For example, step 702 may occur faster than step 704. To compensate, a plurality of microscopes may be employed such that a plurality of discs may be probed simultaneously during the manufacturing process. The plurality of microscope may all be associated with the same computer system or may each be associated with a different computer system. Alternatively, the manufacturing process may only test a pre-determined number of discs being manufactured. For example, one a hundred or one in a thousand discs may be probed.

At 706, the data is fit to a curve at a computer system. The computer system may be computer 304 of FIG. 3. The curve may be a Gaussian curve and may be plotted as depicted by plot 500 of FIG. 5. The Gaussian curve may have a G band, a G position and a G width.

At 708, a position (Gpos) is mapped in function of a full width at half maximum (Gwidth) of a G band of a Gaussian line. The Gpos may be Gpos 508 and the Gwidth may be Gwidth 506 of FIG. 5. Such mapping allows the computer system to analyze the data to make predications.

At 710, a characteristic of the overcoat is predicted based on the curve at the computer system. For example, the characteristics may be a mass density of the overcoat, an sp3/sp2 bonding ratio of the overcoat, and a graphitization of the overcoat. The characteristic may be based on the Gpos and the Gwidth mapping.

At 712, provided the characteristic of the overcoat is outside of a parameter, a manufacturing process for the disc is stopped. For example, parameters may be established at the computer system or another computer system that indicate acceptable measurements for the predicted characteristics of the overcoat. A deviation outside of the parameters may indicate that there is a problem or issue with the overcoats being manufactured making the discs unsuitable for use in a HDD. It may therefore be desirable to stop the manufacturing process rather than continuing to manufacture unsuitable discs. By stopping the manufacturing process, the problem or issue may be diagnosed and correct and the manufacturing process may then resume again. Alternatively, if the predictions of the characteristics of the overcoat are outside of pre-determined parameters, the system used for the manufacturing may generate a notification such as a warning light rather than stopping the manufacturing process.

The present technology may be employed to manufacture discs of varying quality. For example, a company may manufacture several different models of HDDs where different models are lower or higher in quality. The different levels of quality may be due to a plurality of factors one of which may be the quality of the overcoat of the disc. Therefore, a higher quality HDD may require a higher quality overcoat over the disc. Thus, parameters may be employed in the manufacturing process to sort the discs according to the level of quality of the overcoat.

At 714, provided the characteristic of the overcoat is outside of a parameter, the disc is discarded. For example, if the predicted characteristics of the overcoat have deviated significantly outside of the parameters for suitable use in a HDD, the disc may be discarded to ensure a specified level of quality in the HDD.

At 716, provided the characteristic of the overcoat is inside of a parameter, the disc is placed in hard disc drive. Such a placement may be automated and may refer to the next step in the manufacturing process.

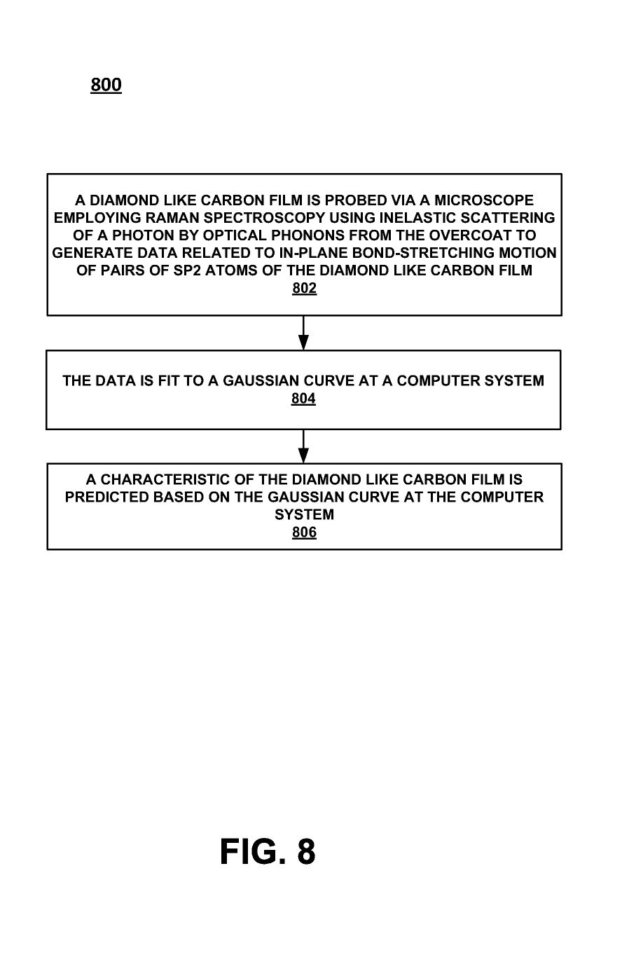

FIG. 8 is a flowchart illustrating process 800 for predicting characteristics of a film, in accordance with embodiments of the present technology. Process 800 may be for a disc used in a HDD such as is depicted in FIGS. 1 and 2. The components used for process 800, as well as its steps and results are depicted in FIGS. 3, 4, and 5.

At 802, a diamond like carbon film is probed via a microscope employing Raman spectroscopy using inelastic scattering of a photon by optical phonons from the overcoat to generate data related to in-plane bond-stretching motion of pairs of sp2 atoms of the diamond like carbon film. For example, the diamond like carbon film may be overcoat 202 of FIG. 2 and the microscope may be microscope 302 of FIG. 3. The probing may be accomplished by sending or shining light onto a surface of the diamond like carbon film such as light 306. The data may be the characteristics of the scattered light, such as scattered light 308, reflected from the surface of the diamond like carbon film and gathered by a sensor associated with the microscope.

The overcoat may be comprised of carbon or diamond like carbon and may be a thin film. A carbon overcoat may be comprised of sp2 and sp3 atoms in bonding pairs. The overcoat may be a layer in a disc to be used in a HDD such as disc 200 of FIG. 2. The microscope may be a confocal Raman microscope that uses Raman spectroscopy.

At 804, the data is fit to a Gaussian curve at a computer system. The computer system may be computer 304 of FIG. 3. The curve may be a Gaussian curve and may be plotted as depicted by plot 500 of FIG. 5. The Gaussian curve may have a G band, a G position and a G width.

At 806, a characteristic of the diamond like carbon film is predicted based on the Gaussian curve at the computer system. For example, the characteristics may be a mass density of the overcoat, an sp3/sp2 bonding ratio of the overcoat, and a graphitization of the overcoat. The characteristic may be based on the Gpos and the Gwidth mapping.

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims. Additionally, in various embodiments of the present technology, the steps and methods described herein do not need to be carried out in the order specified, nor do all steps need to be carried out to accomplish the purposes of the technology.

What is claimed:

1. A method for predicting a characteristic of an overcoat for a media for a hard disc drive, said method comprising:
probing an overcoat via a microscope using inelastic scattering of a photon by optical phonons from said overcoat to generate data related to in-plane bond-stretching motion of pairs of atoms of said overcoat;
fitting said data to a curve at a computer system; and
predicting a characteristic of said overcoat based on said curve at said computer system.

2. The method as recited in claim 1 wherein said characteristic is selected from the group of characteristics consisting of: a mass density of said overcoat, an sp3/sp2 bonding ratio of said overcoat, and a graphitization of said overcoat.

3. The method as recited in claim 1 wherein said overcoat is over a media used as a disc in a hard disc drive.

4. The method as recited in claim 1 wherein said overcoat is composed of diamond like carbon and said pairs of atoms are sp2 atoms.

5. The method as recited in claim 1 wherein said overcoat is a film.

6. The method as recited in claim 1 wherein said microscope is a confocal Raman microscope that uses Raman spectroscopy.

7. The method as recited in claim 1 wherein said curve is a Gaussian line.

8. The method as recited in claim 7 wherein said predicting said characteristic further comprises:
mapping a position (Gpos) in function of a full width at half maximum (Gwidth) of a G band of said Gaussian line.

9. A method for manufacturing a disc for a hard disc drive, said method comprising:
depositing an overcoat over a media for a disc;
probing said overcoat via a microscope using inelastic scattering of a photon by optical phonons from said overcoat to generate data related to in-plane bond-stretching motion of pairs of atoms of said overcoat;
fitting said data to a curve at a computer system; and
predicting a characteristic of said overcoat based on said curve at said computer system.

10. The method as recited in claim 9, further comprising:
provided said characteristic of said overcoat is outside of a parameter, stopping a manufacturing process for said disc.

11. The method as recited in claim 9 further comprising:
provided said characteristic of said overcoat is outside of a parameter, discarding said disc.

12. The method as recited in claim 9 wherein said method of manufacturing said disc manufactures a plurality of discs and wherein said probing said fitting and said predicting occur for only a portion of said plurality of discs.

13. The method as recited in claim 9 wherein said characteristic is selected from the group of characteristics consisting of: a mass density of said overcoat, an sp3/sp2 bonding ratio of said overcoat, and a graphitization of said overcoat.

14. The method as recited in claim 9 wherein said overcoat is over a media used as a disc in a hard disc drive.

15. The method as recited in claim 9 wherein said overcoat is composed of diamond like carbon film and said pairs of atoms are sp2 atoms.

16. The method as recited in claim 9 wherein said microscope is a confocal Raman microscope that uses Raman spectroscopy.

17. The method as recited in claim 9 wherein said curve is a Gaussian line.

18. The method as recited in claim 17 wherein said predicting said characteristic further comprises:
mapping a position (Gpos) in function of a full width at half maximum (Gwidth) of a G band of said Gaussian line.

19. A method for predicting a characteristic of a film, said method comprising:
probing a diamond like carbon film via a microscope employing Raman spectroscopy using inelastic scattering of a photon by optical phonons from said overcoat to generate data related to in-plane bond-stretching motion of pairs of sp2 atoms of said diamond like carbon film;
fitting said data to a Gaussian curve at a computer system; and
predicting a characteristic of said diamond like carbon film based on said Gaussian curve at said computer system.

20. The method as recited in claim 20 wherein said characteristic is selected from the group of characteristics consisting of: a mass density of said diamond like carbon film, an sp3/sp2 bonding ratio of said diamond like carbon film, and a graphitization of said diamond like carbon film.
